(19) United States
(12) Patent Application Publication
(10) Pub. No.: US 2004/0088317 A1
(43) Pub. Date: May 6, 2004

(54) Methods, system, software and graphical user interface for presenting medical information

(76) Inventors: Allan Fabrick, Austin, TX (US); Jerry Langley, Cameron Park, CA (US)

Correspondence Address: SIMON, GALASSO & FRANTZ PLC., P.O. Box 26503, Austin, TX, 78755-0503, US

(21) Appl. No.: 10/617,079

(22) Filed: Jul. 10, 2003

Related U.S. Application Data
(60) Provisional application No. 60/395,576, filed on Jul. 12, 2002.

(51) Int. Cl. G06F 7/00

(52) U.S. Cl. 707/102

(57) ABSTRACT

Various methods, systems, software and graphical user interfaces are described herein to enable a medical provider to generate forms and reports customized to a particular patient's medical conditions. When a medical professional treats a patient, the invention disclosed herein permits a customized dynamic form to be presented to the medical provider, either in print or via a computer graphical user interface, wherein the form includes information related to the particular medical conditions of a that patient. Unlike “one size fits all” forms commonly provided to doctors or other medical professionals, forms and reports as taught herein permit medical professionals to see “the big picture” by having substantially all information relevant to a patient's medical condition in a unified format. Various embodiments discussed herein permit changing a form interactively based on a current diagnosis, and generating customized patient reports.

### CROSS REFERENCE TO RELATED APPLICATIONS

This application claims the benefit under 35 U.S.C. §119(e) of U.S. Provisional Patent Application Serial No. 60/395,576, entitled “Methods, System, Software And Graphical User Interface For Presenting Medical Information”, which was filed on Jul. 12, 2002

### FIELD OF THE DISCLOSURE

The present invention relates generally to presenting medical information to a care provider, and more particularly to presenting the medical information in a customized format.

### BACKGROUND

Most medical record systems rely on preprogrammed templates, forms or other fixed format frameworks to display, enter and edit patient data. This means that if a medical provider wants to view, edit or enter a specific piece of information, he must often go through many screens to find the location where that piece of information resides. This becomes increasingly troublesome when a patient has multiple conditions. To view, enter or edit such a patient's data can require the provider to go through ten, twenty or even more screens. Besides the time spent going through so many screens, the data are never seen together in one place so that the provider can better synthesize and integrate the information. Adding new conditions or modifying current displays requires the resources of computer programmers, analysts or other technical specialists.

In addition to the limitations of electronic medical record systems used interactively with a computer, presently available hard copy forms provided to doctors or other healthcare providers usually include information that is limited to certain predefined combinations of conditions. For example, a doctor seeing a patient who suffers from diabetes may be given a form that includes relevant information for patients with diabetes in general. This “diabetes” form is available because a programmer or other technical specialist has taken the time to construct the form in advance. While preconstructed forms may be useful to a health care provider in providing health care services to some patients, only a limited number of predefined form types are available. For example, if the patient with diabetes were also to suffer from conditions unrelated to diabetes, such as a broken leg and malaria, no predefined form would be available for that particular combination of medial issues.

What is needed, therefore, is a way to present medical data that is not limited to certain preconstructed form types.

### BRIEF DESCRIPTION OF THE DRAWINGS

Various advantages, features and characteristics of the present disclosure, as well as methods, operation and functions of related elements of structure, and the combination of parts and economies of manufacture, will become apparent upon consideration of the following description and claims with reference to the accompanying drawings, all of which form a part of this specification.

FIG. 1 is a flow diagram illustrating patient information being stored into a database and then used to generate customized forms for a medical provider according to an embodiment of the present disclosure;

FIG. 2 is a flow diagram illustrating how patient information included in a database can be used to generate dynamic reports at the request of an end user, without requiring a programmer or other technical professional to construct the reports in advance, according to an embodiment of the present disclosure;

FIG. 3 is a flow chart illustrating a method according to an embodiment of the present disclosure;

FIG. 4 is a screenshot of an encounter document that may be used to enter data for a particular patient upon that patient's initial visit to a health center, according to an embodiment of the present disclosure;

FIG. 5 is a screen shot of an encounter document that may be generated for a patient having diabetes, according to an embodiment of the present disclosure;

FIG. 6 is a screenshot of an encounter document that may be used for the same patient diagnosed with diabetes in FIG. 5, when that patient is further diagnosed with coronary artery disease, according to an embodiment of the present invention;

FIGS. 7 and 8 are screenshots showing additional encounter documents for the same patient discussed in FIGS.5 and 6 when that patient is later diagnosed with depression and asthma, according an embodiment of the present disclosure;

FIG. 9 is a screenshot of a run chart display generated according to an embodiment of the present disclosure;

FIGS. 10-12 are a pick list used to select medical issues to be added to encounter documents for a particular patient, according to an embodiment of the present disclosure;

FIGS. 13-15 are screenshots showing data entry screens according to an embodiment of the present disclosure;

FIGS. 16-18 are forms generated in response to a user query, according to an embodiment of the present disclosure;

FIGS. 19-28 are screenshots illustrating various data entry screens presented using a graphical user interface according to an embodiment of the present disclosure;

FIG. 29 is a screenshot illustrating a report selection screen according to an embodiment of the present disclosure; and

FIG. 30 is a block diagram illustrating a processing system used to implement various embodiments of the present disclosure.

### DETAILED DESCRIPTION OF THE FIGURES

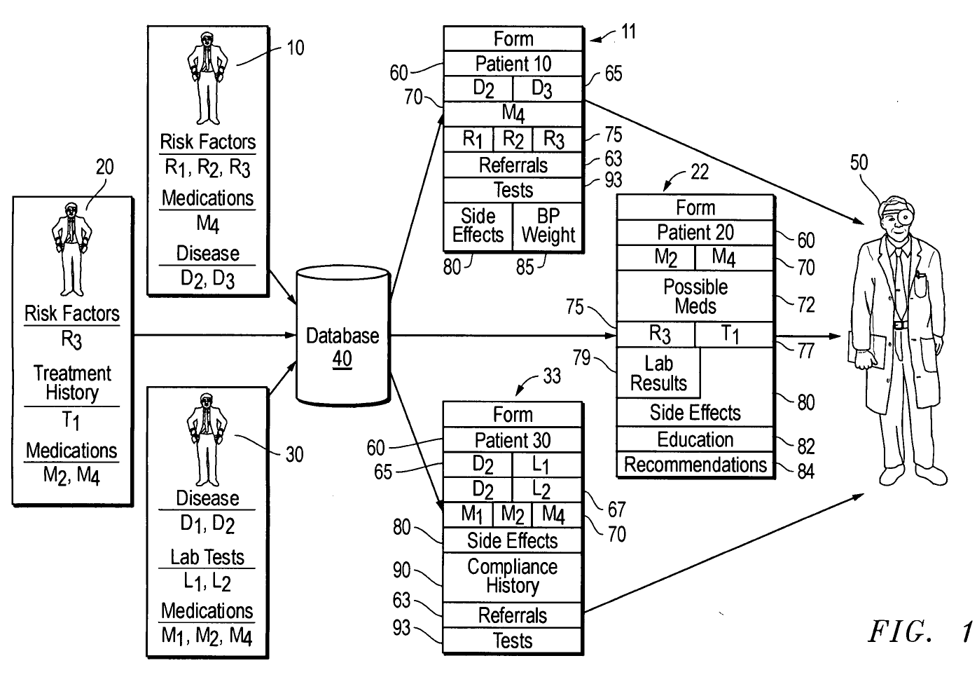

FIGS. 1-30 illustrate generally a system, software, graphical user interface (GUI) and methods for providing customized information relating to a particular patient's medical conditions to a health care provider. By providing customized electronic or printed forms including all or nearly all relevant information related to a particular patient's medical conditions, it becomes easier for a health care provider to make appropriate “big picture” decisions for that patient, and to ensure that that patient receives appropriate care. In addition to providing either electronic or printed forms that a health care provider can use in treating a patient, a health care provider or other end user can also use various embodiments of the present disclosure to generate customized reports about his patients, using any number of criteria, without requiring a programmer or other technical professional to prepare forms or reports in advance. Still other embodiments can be used to create customized data entry forms. The forms are generated based on patients' individual medical issues, and may include information associated with demographics, vital statistics, diagnosed conditions, medications, laboratory or other diagnostic tests, vaccinations and immunizations, risk factors, referrals, notes, procedures and services, or other relevant information. These forms can then be used to aid in data entry, data retrieval, patient care, etc.

By allowing end users, such as medical professionals and their staff, to generate customized/dynamic reports and forms, both large clinics and smaller practices may reduce the need for huge staffs of analysts and technical specialists to construct desired forms in advance. The flexibility provided by various embodiments described herein can also lead to more efficient and more effective health care being provided to the patients. For example, if a new health care provider is working at a clinic, and the health care provider is unfamiliar with the patients he or she is serving, the customized forms described herein can be used to aide that provider in quickly familiarizing himself with the patient and their treatment history. In addition, best practices and care guidelines developed by a particular clinic, medical practice, etc., may be included on the customized forms to facilitate uniform treatment of patients. In addition, various embodiments of the present disclosure allow customized reports and/or forms to be saved as templates which can then be shared with other medical providers to save even more time.

Referring first to FIG. 1, an embodiment of the present disclosure will be discussed. Patients 10, 20 and 30 each have particular medical issues, or conditions, that may need to be dealt with. For example, patient 10 has risk factors R1, R2 and R3, takes medications M4 and suffers from diseases D2 and D3. Patient 20 has risk factors R3, has a treatment history T1 and currently takes medications M2 and M4. Finally patient 30 suffers from diseases D1 and D2, has had lab tests L1 and L2, and is taking medications M1, M2 and M4. Each of the patients 10, 20 and 30, have individual medical care needs, which can only be addressed properly by considering all of their medical conditions. For example if treating disease D2 in patient 10 could conflict with treatments for disease D3, then medical care provider 50 would need to know that patient 10 has both diseases D2 and D3. Likewise if medical care provider 50 desires to treat patient 30 for disease D2 by providing an extra medication, it is important for medical care provider 50 to know that patient 30 is all ready taking medications M1, M2 and M4 to prevent any possible interactions between the medications.

In order to provide health care provider 50 with the most comprehensive information in an integrated and easy to use format, the information from each of the patients 10, 20 and 30 can be stored in database 40. The information from database 40 can then be used as a basis for selecting particular fields to include on patient care forms 11, 22 and 23. For example patient care form 11 would be provided to medical care provider 50 when medical care provider 50 is treating patient 10.

Patient care form 11 includes the following fields: patient identification field 60; disease field 65; medication field 70; risk factor field 75; referral field 63; test field 93; side effects field 80 and vital statistics field 85. Each of the fields presented on patient care form 11 is selected based on information about patient 10 retrieved from database 40. As a result, disease field 65 shows the diseases that patient 10 suffers from, while patient identification field 60 identifies patient 10 uniquely. Each of the other patient care forms 22 and 23 include information appropriate to the treatment of the corresponding patient whose identity is listed in patient identification field 60. Some examples of information that may be included in patient careforms n, 22, and 33 are discussed in the following paragraphs.

The patient identification field 60 may include demographic information such as patient name, address, homeless status, gender and the like. This tends to be data that does not change frequently or changes slowly. Disease field 65 may include diagnosed medical conditions, the date of diagnosis, diagnosing provider, date of onset, diagnosis notes, cure date, cure notes, cure provider, and similar information. Sub categories of these diagnosed conditions may include chronic diseases and acute diseases. Medication field 70 is generally used to general information relating to prescribed medicates, and may include information such as the date of prescription, the prescribing provider, prescription notes, dosage, pathway, number of refills, frequency, prescribed amount, whether the medication has been discontinued, discontinuation notes, whether medications are contraindicated and similar information. Risk factor field 75 may include such information as family history, occupational factors, behaviors that may put the patient at risk or positive behaviors that may have a positive impact on the patient's treatment. Referral 63, in at least one embodiment, includes referrals and education information such as the dates of referrals, the organizations or facilities to which the patient has been referred, and may include information such as diabetes education and the like. Test field 93 may identify diagnostic tests that have non-numeric results, such as echocardiograms and the like, procedures performed by the provider and staff that are not normally classified as laboratory tests, and other tests as may be appropriate. While laboratory tests could be included in the test field 93 generally, it may be preferable to provide a separate field as lab test field 67 to hold information relating to laboratory test results. In at least one embodiment lab test field 67 includes laboratory test result information such as the test date, the test value, the units of the test, the testing organization or provider and the like.

Side effects field 80 may be a separate field from medication field 70, and may be used to bring particular attention to any side effects of medication, laboratory tests or other treatment regimes that may effect the treatment of a particular patient. In at least one embodiment side effects field 80 is used by a medical clinic to bring special attention to side effects of new or infrequently prescribed medications. Vital statistics field 85 includes information about a patient such as their blood pressure, their weight and similar information.

Possible medication field 72, which is used in patient care form 22, is an example of care guidelines used in at least one embodiment of the present disclosure. In the illustrated example the care guidelines may provide that certain medications be used in place of other, more standard medications, due to the treatment history T1 of patient 20. For example if patient 20 is allergic to penicillin then possible medication 72 may show suggested medications to use in place of penicillin for treating patient 20.

Treatment history field 77 can be used to provide health care provider 50 with either a brief summary or a detailed account of the treatment history of patient 20, as may be needed to properly provide care for the patient. For example treatment history field 77 may include information about patient 20 that indicates the dates which patient 20 has been diagnoses with particular problems, or it may provide information tending to indicate that patient 20 does not respond well to a particular treatment regime. This information can be used along with the other information provided in patient care form 22 to provide the best quality medical care possible for patient 20.

Education field 82, in one embodiment, may be separate from referral field 63, and may include information such as whether patient 20 has attended a weight loss management program, a depression management program, an alcohol management program, a smoking cessation program, and the like. Recommendation field 84 may be provided so that a previous health care provider can leave notes to future health care providers indicating the previous providers recommendations for treatment. In addition the recommendation field 84 may include information generated by a particular clinic in order to standardize the health care provided by that clinic amongst various doctors. Compliance history field 90 may be used in addition to other fields provided on patient care forms 11, 22 and 33 in order to indicate whether a patient has complied with previous care directives. For example if patient 30 has been prescribed particular medications, and it becomes known that patient 30 is not taking the medications in the proper doses and at the proper times, compliance history 90 could be used by health care provider 50 to alter, adjust or change the treatment regime prescribed for patient 30 so that patient 30 would be more likely to follow the prescribed treatment.

It will be appreciated that the particular form fields described with reference to FIG. 1 may include additional or less information, may be rearranged, added, or omitted, based on the preferences of medical provider 50. In at least one embodiment, medical provider 50 can suppress particular fields from being included in patient care forms 11, 22 and 23, if medical care provider 50 feels that the fields are not necessary for him to review. In addition, medical care provider 50 may select additional fields to include on patient care forms 11, 22 and 23 if he so desires. In any case, no programmer or technical specialist is needed to preconstruct the forms, instead, each patient care form 11, 22 and 33 can be individually customized to best meet the needs of health care provider 50 and the patients 10, 20 and 30 whom health care provider 50 is treating.

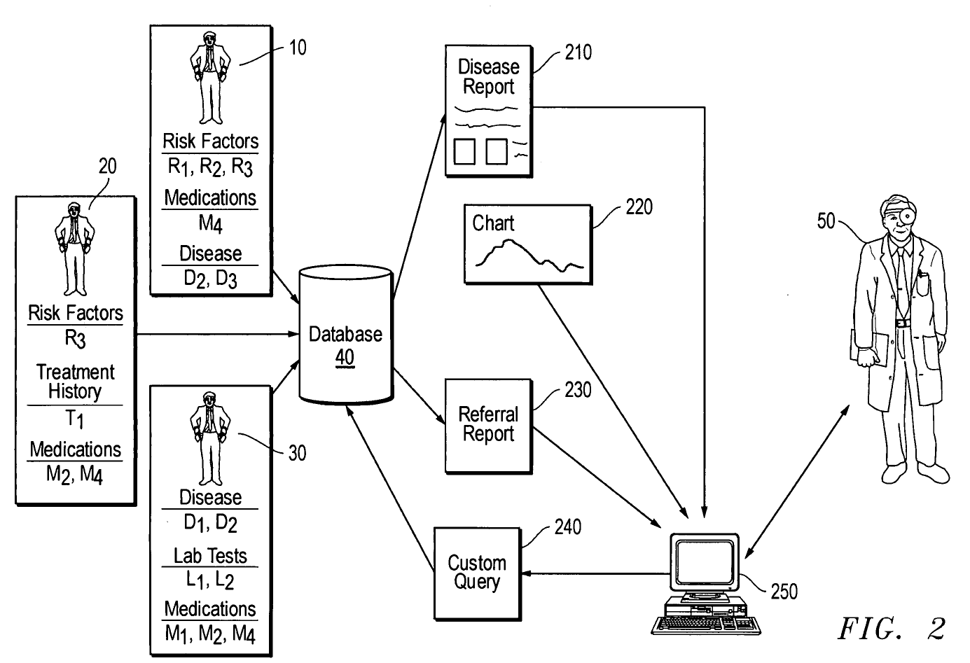

Referring now to FIG. 2 a method of obtaining reports will be discussed according an embodiment of the present disclosure. In. the present example, patients 10, 20 and 30 have information associated with their medical conditions stored in database 40. Health care provider 50 desires to retrieve reports associated with patients 10, 20 and 30 to evaluate the efficacy of a particular treatment regime. For example, health care provider 50 may desire to know how many of his patients have a particular disease and whether his clinics treatment of that disease has been effective. In order to find that information, health care provider 50 may desire to retrieve a report from database 40 such as disease report 210. Disease report 210 may include any number of fields as selected by health care provider 50, and may be constructed using various queries and conditions deemed to be important by health care provider 50. Unlike many previous medical database reports, a template or format of disease report 210 does not need to be preconstructed by a technical professional, instead health care provider 50 can interactively and dynamically construct disease report 210 to meet his own personal requirements.

Instead of, or in addition to, disease report 210 medical care provider 50 may desire to view the results of a query as a chart, such as chart 220. As with disease report 210, the exact format and contents of chart 220 can be determined by medical provider 50 without resort to a programmer or technical database specialist. Alternatively, medical care provider 50 may desire to run other reports such as a referral report 230. Referral report 230 may include information such as frequency of referrals, types of referrals, to whom referrals have been made, whether referral appointments have been kept, or any number of variations as desired by medical care provider 50. Again referral report 230 may be generated without resort to a pre-configured report created by a specialist. It will be appreciated that while disease report 210, chart 220 and referral 230 are illustrated in FIG. 2, medical provider 50 can customize and dynamically request an almost infinite different number of reports based upon categories and rules medical provider 50 selects, rather than predefined/pre-constructed charts, reports, etc.

In order to request one of these reports or charts, medical provider 50 simply interacts with processor 250, which may be a handheld computing device, a portable computing device, a desktop computing device, or any other suitable form of processing system. Processor 250 then generates the custom query 240 based on the categories and rules selected by medical provider 50. This custom query 240 is then used to retrieve information from database 40 and allow processor 250 to construct the various reports, charts, etc which may be requested by medical provider 50. It will be appreciated that while FIG. 2 shows reports 210, 230 and chart 220 as being constructed and then delivered to processor 250, processor 250 may retrieve the data and construct the reports local to itself, rather than relying on reports or charts to generated externally.

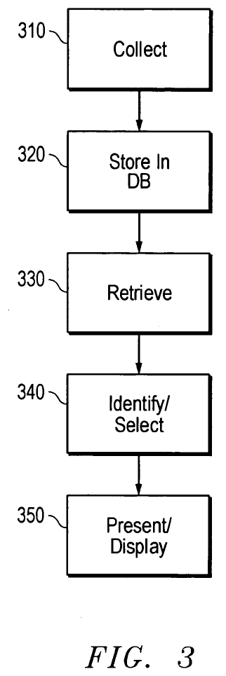

Referring next to FIG. 3 a method according to one embodiment of the present disclosure will be discussed. The method illustrated in FIG. 3 begins in step 310 with the collection of information associated with an individuals medical condition. Collecting, or obtaining the information may include gathering information from a patient using a written questionnaire, an oral question and answer session, or any other suitable means. In at least one embodiment, collecting the information can be performed using an oral question and answer session while a staff member or other end user enters the data into a computer using a graphical user interface. The graphical user interface used for entering the data is, in at least one embodiment, constructed to facilitate entry of each element of patient data as an individual item.

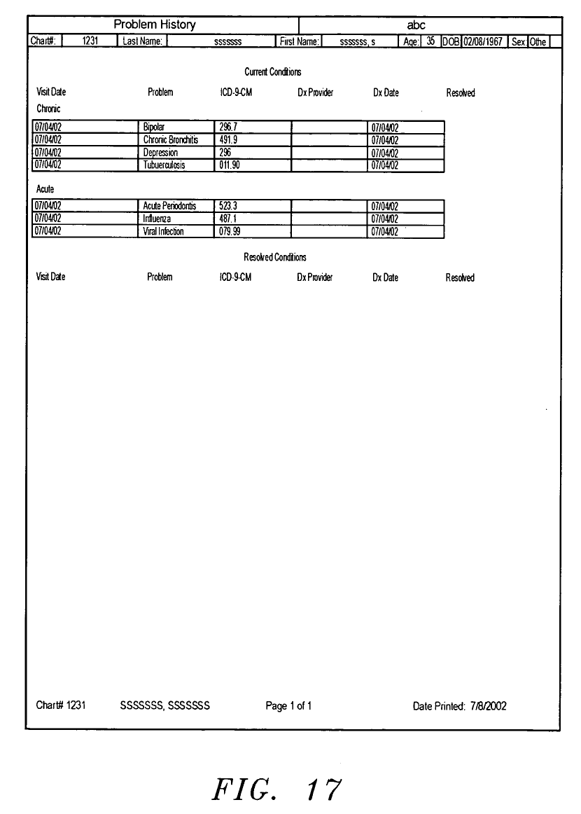

The data entry forms used by the graphical user interface during the data collection of step 310, can be customized in much the same way as the forms used by medical provider 50, as discussed with reference to FIG. 1. For example, if the data collection is being performed during a subsequent office visit, and during a previous office visit a customized form was created for that patient, the customized form can be used as a basis for data entry during the subsequent visit. While various methods of collecting data relating to a patient's medical conditions may be used, a specific embodiment employing a graphical user interface will be discussed subsequently with reference to FIGS. 19-28.

After the data is collected in step 310, it is stored in a database during step 320. In at least one embodiment a commercially available database such as ACCESS can be used. Alternatively, a custom created database program may be employed. Items in the database may be organized in a multi-level hierarchy. At the bottom level all items have a specified storage type. Additional levels of hierarchy are used to group items. Computed items, i.e., those items whose value is calculated from other information, are a special case. Information about how to display each level of the hierarchy may be determined by an algorithm that examines the item related items and overrides. As used herein, the term “primary” item refers to patient related information.

The term “related item” refers to an element to be displayed on a dynamic form if a related primary item is displayed on the form, and if the primary item contains a non-null value. For example, if a patient is taking a particular drug to treat a medical condition, then the name of the drugs will be entered as a primary item in the database. A related item may be a known side effect of that drug. If the name of the drug is to be displayed on a patient care form, then the known side effect of that drug is also displayed on the form. If, however, the patient were not taking the particular drug, the side effect would not be printed or displayed on the dynamic form.

The term “override item” as used herein, is an item that will not appear on a specific form because of a user preference. For example if a patient is only taking one drug, and the potential side effect for that drug is very minor, a physician may decide that he does not need to be reminded of that side effect for that particular patient. Therefore, the medical provider could suppress the display of the side effect of that drug so that although it is a related item, and although the patient is taking the drug, the side effect will not be displayed on the form.

After the information is stored in the database in step 320, the data can be retrieved in step 330. The information can be retrieved interactively using forms similar to those described with relationship to FIG. 1, but may be retrieved by other more conventional methods. For example, in at least one embodiment, a processor being used to generate a patient care form may simply send a request to a database, located either locally or remotely, and the database would send all required information, including primary items, related items and override items, back to the processor being used to generate the patient care form.

After the information is retrieved in step 330, particular information to be presented on a form or report is identified/or selected in step 340. In general, when constructing a dynamic form according to one embodiment of the present disclosure, after the patient data is collected and items containing values are properly noted, related items are flagged to be added to the dynamic form based on whether primary items are included on that form. After the primary and related items are identified, override items are flagged for removal, so that the overridden items will not be displayed or presented in step 350.

Recall that both primary and related items, are identified and selected according to whether they are appropriate for a particular patient. For example, in more conventional applications, pre fabricated form templates are used, and the only choice an end user can make is to select which of the form templates should be printed or displayed. In the present disclosure however, the end user has significant control not only over which forms and reports may be displayed, but also over the information contained in those forms. So, for example, instead of generating a form for diabetes generally, each patient can have a custom form that provides information uniquely suited to that particular patient.

The forms that include the information selected in step 340 are then presented or displayed in step 350. The presentation of the forms may include printing the forms or displaying the forms on a computer or other display, such that an end user can interactively add information to the form as desired. The form may also be saved in a file format for use by other programs such as Excel, Word Perfect, etc.

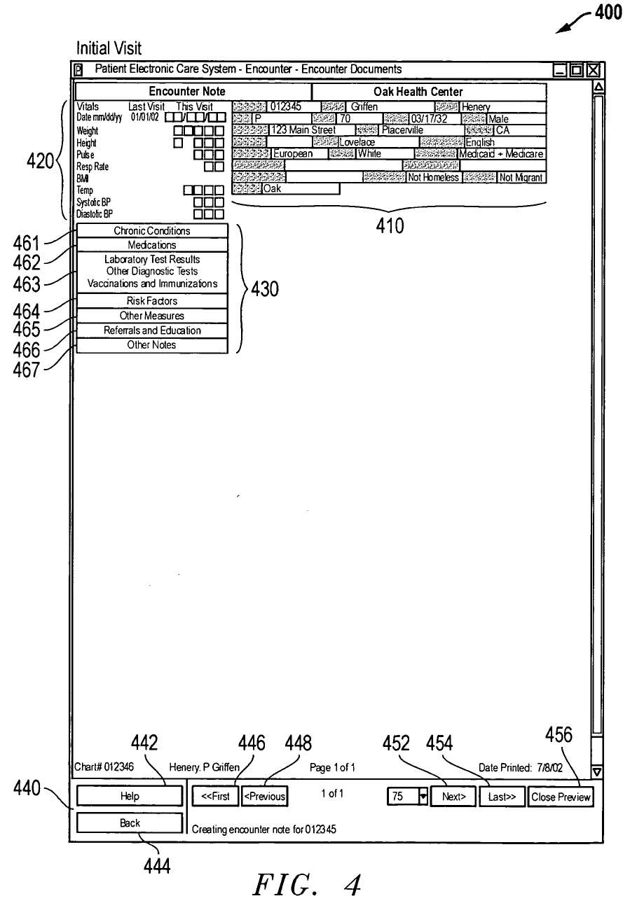

Referring next to FIG. 4, an encounter note for a patient's initial visit will be discussed according to one embodiment of the present disclosure. The encounter note illustrated in screenshot 400 may be used to facilitate gathering information from a patient during his initial visit to a particular health care facility. The information included in the screenshot 400 includes demographics area 410 for gathering demographic information, and vital statistics area 420 to facilitate gathering information associated with the patient's vital statistics. Also present in the screenshot 400 is additional information area 430, which can be used to aid in gathering data about the patient's medical conditions. For example, the list of items in additional information area 430, which in the illustrated embodiment includes user selectable object chronic conditions 461, medications 462, laboratory test results other diagnostic tests vaccinations and immunizations 463, risk factors 464, other measures 465, referrals and education 466 and other notes 467, may each be individually selectable objects displayed on a computer screen. When any of these objects is selected by user, an additional screen having pertinent information related to the selected object will be displayed. Data entry using these screens is discussed subsequently in relationship to FIGS. 19-29.

Towards the bottom of screenshot 400 are another series of user selectable objects to implement interactive access to various other screens. For example, a help button 442 may be used to call a help screen which a user can then interact. Other buttons, such as back button 444, first button 446, previous button 448, next button 452, last button 454 and close preview button 456, may also be used to navigate to other display screens, or to call other portions of a program implemented according to various embodiments of the present disclosure. It will be appreciated that the information displayed in screenshot 400, can be customized as desired to facilitate data collection by a medical practitioner or institution.

Referring next to FIG. 5, an encounter document illustrating fields that may be displayed for a diagnosis of diabetes are shown in screenshot 500, according to an embodiment of the present disclosure. Screenshot 500 includes many of the same objects shown in screenshot 400. However, screenshot 500 does not include additional information area 430, but includes instead chronic conditions area 532, medications area 534, laboratory test results area 536, other diagnostic tests area 537, vaccinations and immunizations area 538, risk factors area 533, other measures area 535, referrals and education area 539 and other notes area 531. Areas 531-539 are expanded areas associated with the user selectable objects shown in additional information area 430 (FIG. 4), and include user selectable objects and information associated with a diagnosis of diabetes.

Note that in chronic conditions area 532, a small checkbox next to diabetes Type I is provided. This checkbox may be selected by a user to indicate that the patient has been cured of his Type 1 diabetes. Note that below Diabetes Type I, there is a section entitled Potential Chronic Diseases. Listed under Potential Chronic Diseases are diseases which are often associated with Type I Diabetes. Next to each of the listed diseases is an Add checkbox, which can be checked if the patient is diagnosed with one of the listed diseases. If one of the Add checkboxes is selected additional information associated with the newly checked disease will be provided in the encounter document.

Similarly, the medications listed in medications area 534 are medications that are likely to be needed by someone with Type I Diabetes. Each of the medications in medications area 534 can be selected in a manner similar to the manner in which diseases can be selected in chronic conditions area 532. Likewise laboratory test results area 536 lists laboratory tests that are likely to be needed by someone having type I diabetes. Other diagnostics tests 537, vaccinations and immunizations area 538, risk factors area 533, other measures area 535, referrals and education area 539 and other notes area 531 likewise include information that is related to the medical condition of the patient listed in patient identification field 410.

By accessing the encounter document shown in screenshot 500 through a graphical user interface, each of the listed conditions, medications, etc. may be selected by a user to modify the encounter document shown in screenshot 500. In other embodiments, however, the encounter document shown in screenshot 500 is provided to a medical practitioner in a paper form. The medical practitioner can then fill in appropriate information on the paper form and then provide the form to a staff member for data entry.

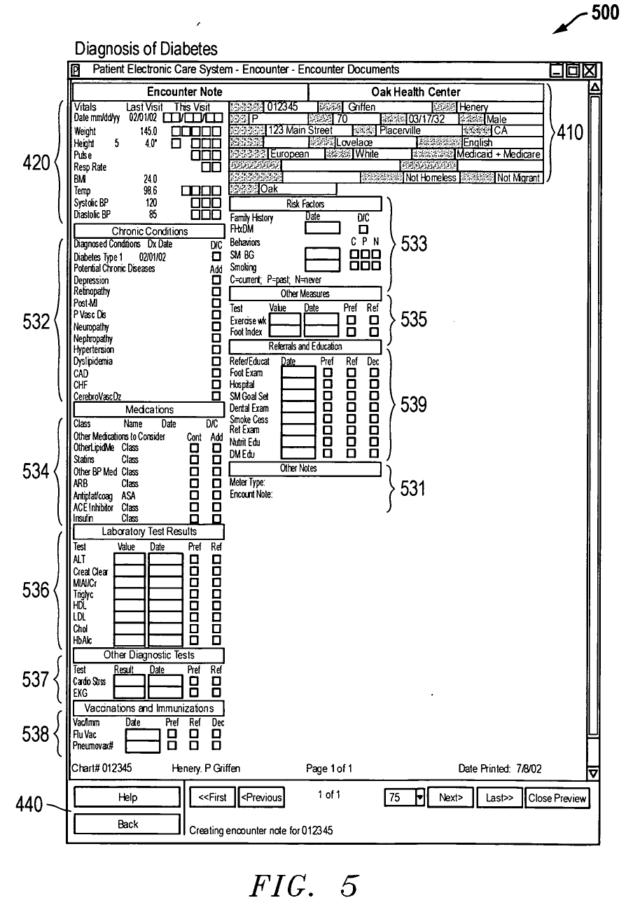

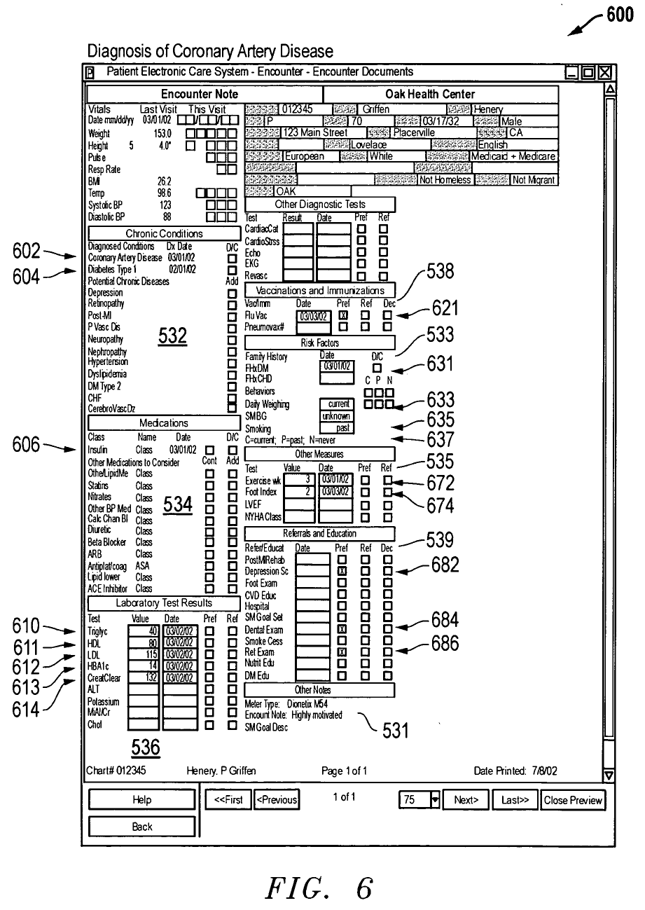

Referring next to FIG. 6, an encounter document for the same patient discussed with reference to FIGS. 4 and 5 will be discussed according to an embodiment of the present disclosure. In screenshot 600, an encounter document is shown for a visit in which the patient is diagnosed with coronary artery disease 602 in addition to Type I Diabetes 604. Medications area 534 shows that the patient has been prescribed insulin 606, and laboratory test results area 536 lists the results of tri-glyceride test 610, HDL test 611, LDL test 612, HBA1C test 613 and Creatinine Clear test 614. In addition, as can be seen in vaccinations and immunizations area 538, the patient has had the flu vaccine 621.

Additional risk factors have been added to risk factor area 533, and risk factor FHxDM 631 has been identified, while the behaviors of daily weighing 633, SMBG 635 and smoking 637 have been addressed. In other measures area 535, it is noted in item 672 that the patient exercises three times per week and has a foot index 674 of two. Under referrals and education area 539 the prepare referral checkbox for depression 682, dental exam 684 and retinal exam 686 are marked, while other notes area 531 shows that the patient is highly motivated, indicates the type of meter being used by the patient, and indicates that goals have been described. Again recall that the encounter document illustrated in screenshot 600, may be provided to a medical practitioner in printed form such that the medical practitioner can check boxes or fill in blanks or, the medical practitioner can view the encounter document through a graphical user interface thereby allowing the practitioner to interact with the various fields and objects presented in the encounter document of screenshot 600.

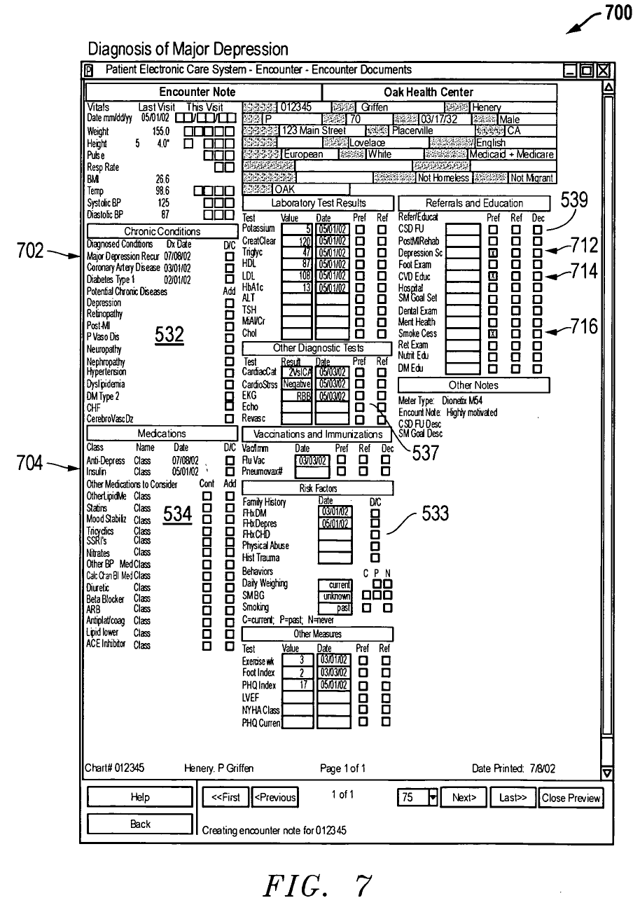

Referring next to FIG. 7, a screenshot 700 of an encounter document for a subsequent visit of the same patient discussed in FIGS. 4-6 will be discussed. The encounter document shown in FIG. 7 indicates that the patient has been diagnosed with recurring major depression 702 as indicated in chronic conditions 532. Note that when major depression was diagnosed and added to the encounter document shown in screenshot 700, related information associated with the patient's newly diagnosed illness was also added. For example, major depression 702 is now a diagnosed chronic condition instead of a potential chronic disease. In addition, the patient has been prescribed anti-depressant 704 (see Medications area 534), more diagnostic tests have been prescribed (see other diagnostic tests area 537), and additional risk factors have been added and identified (see risk factor area 533). Also, referrals and education area 539 shows that referrals for depression counseling 712, CVD education 714 and a mental health referral 716 are to be prepared. Note once again that as additional medical issues and/or conditions are added on subsequent visits of the same patient, the encounter document changes to match the patient's needs. Extraneous information is avoided, while information pertinent to the patient's medical conditions is provided and updated.

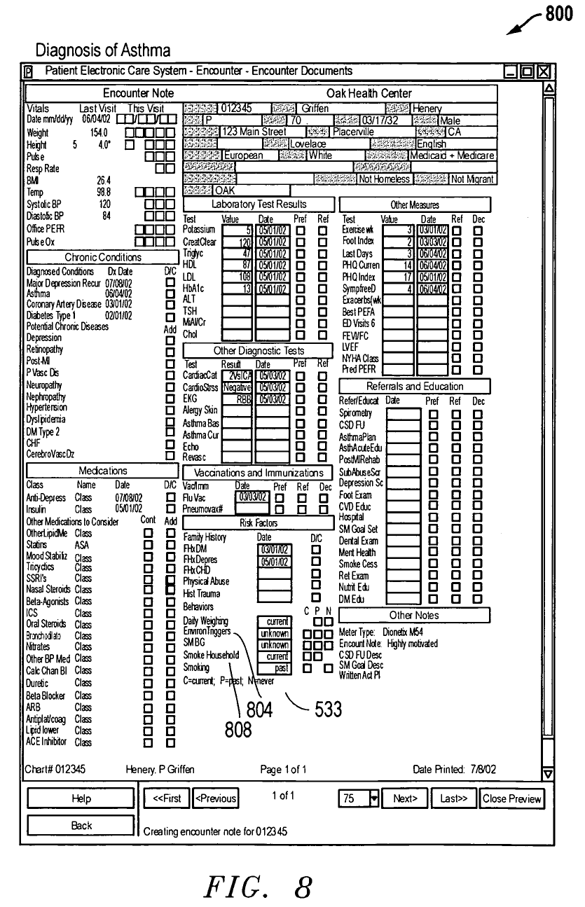

Referring next to FIG. 8, a final encounter document is shown in screenshot 800. The final encounter document shown in screenshot 800 is for a subsequent visit of the same patient discussed in FIGS. 4-7. Now, however, the patient has also been diagnosed with asthma and appropriate additional related information is added to the encounter document. For example, the risk factors of environmental triggers 804 and smoking in the household 808 are now indicated in risk factor area 533. These two risk factors were not present in the encounter document until the patient was diagnosed with asthma.

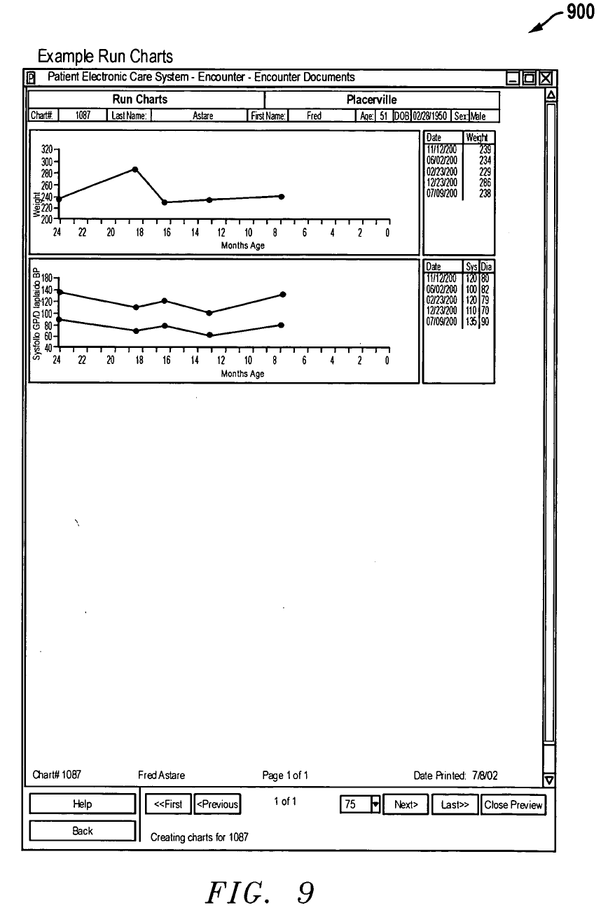

Referring next to FIG. 9 run charts are illustrated and discussed according to an embodiment of the present invention. Run charts 900 illustrate how patient information can be output into a report according to one embodiment of the present disclosure. For example, a medical provider may desire to track the blood pressure and weight of a particular patient or setup patients over time. As discussed with reference to FIG. 2, the medical provider may construct a database query and command run charts, such as run charts 900, to be constructed from data stored in the database. In at least one embodiment, run charts 900 may also be included in the information provided on an encounter form. However, in other embodiments run charts are simply instances of reports that can be generated according to an end user's instructions.

Referring next to FIGS. 10-12, a generic pick list is illustrated, and designated generally pick list 1000. Pick list 1000 may be used in an interactive mode to add additional elements to an encounter note, a pick list may be chosen. When the pick list is displayed, the user selects as many or as few as the listed elements as desired for inclusion in a desired encounter note. It will be appreciated that the pick list may be tailored such that only a portion of the elements listed in pick list 1000 will be selectable, depending on the diagnosed medical conditions of a particular patient. However, in at least one embodiment any or all of the listed elements in pick list 1000 may be chosen for any patient, and the selected elements will subsequently be displayed on patient's encounter note.

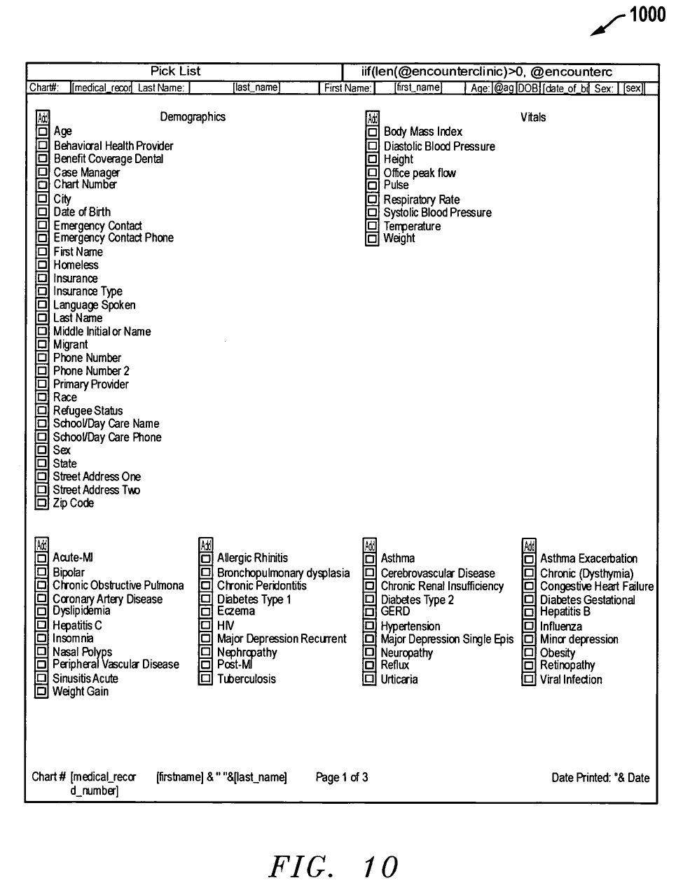

Pick list 1000 may also be used to suppress elements from display on a patient's encounter list. For example, if a patient has asthma, and a previous medical provider has listed Triggers Bird 1205 (see FIG. 12) in the behaviors category of the encounter note, but it has since been determined that birds are not actually a trigger, Triggers Bird 1205 may be deselected so that Triggers Bird 1205 does not appear on any future encounter notes for the patient in question. However, if Triggers Bird 1205 were to be reselected at a later date, then the information originally stored in the database and associated with the Triggers Bird 1205 would once again be displayed.

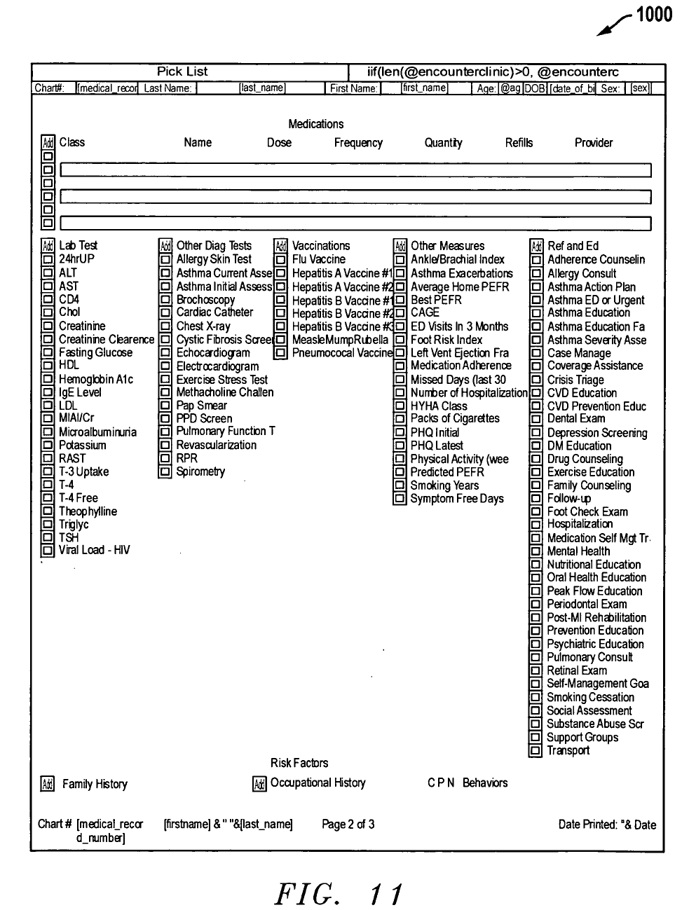

Referring next to FIGS. 13-15, three screens used to access the various features and functions of an embodiment of the present disclosure are illustrated. FIG. 13 illustrates an introductory screen, which indicates the version of the software being used, the users name, the location of the user and the product ID of the software. In addition to this information, a number of user selectable objects are provided on the left side of the screen to facilitate navigation to other screens within the program. For example, Encounter 1302 might cause an initial encounter note selection screen to be displayed, while Reports 1304 causes a query entry screen to be displayed.

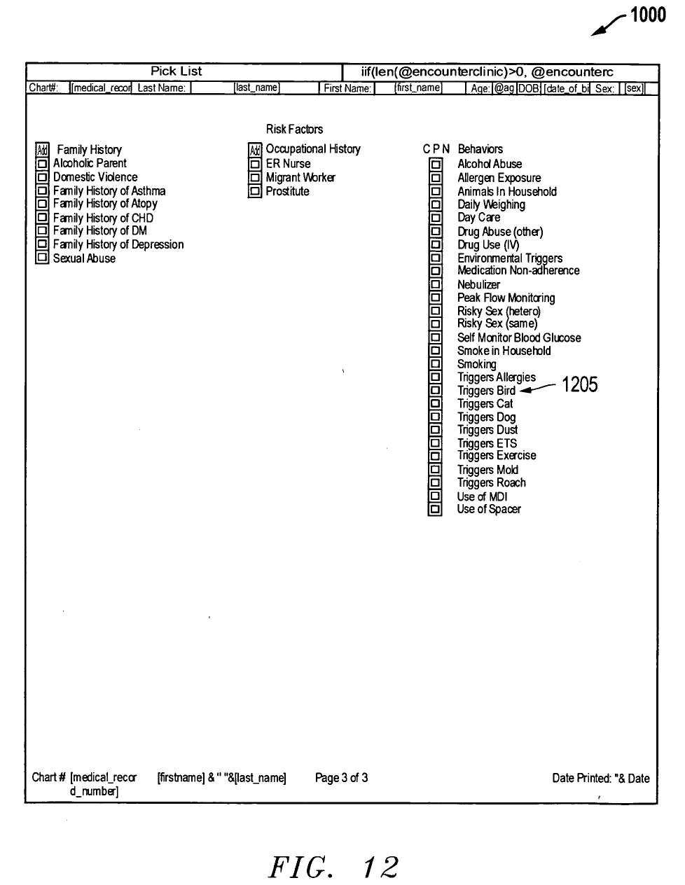

FIG. 14 shows an initial encounter note selection screen, in which a user may select one or more of the conditions listed in the menu 1404 for inclusion in an initial encounter note. Two of the user selectable objects shown on the left side of the screen are blank encounter note 1408, and pick list 1412. Blank encounter note 1408 may be used to generate an encounter note in which no initial conditions have been selected from menu 1404. For example the initial visit encounter document illustrated in screenshot 400 of FIG. 4 was created selecting blank encounter note 1408. The pick list discussed in FIGS. 10-12 was generated by selecting pick list 1412.

In addition to blank encounter note 1408 and pick list 1412, further user selectable objects illustrated in FIG. 14 include a drop down menu 1418, which allows the user to select a particular patient, clinic, provider, etc. for which an encounter note is to be generated. Various other user selectable objects such as help button1422, back button 1424, ok button 1426, cancel button 1428, print button 1430, print preview button 1432 and refresh patient list button 1434 are also shown in FIG. 14.

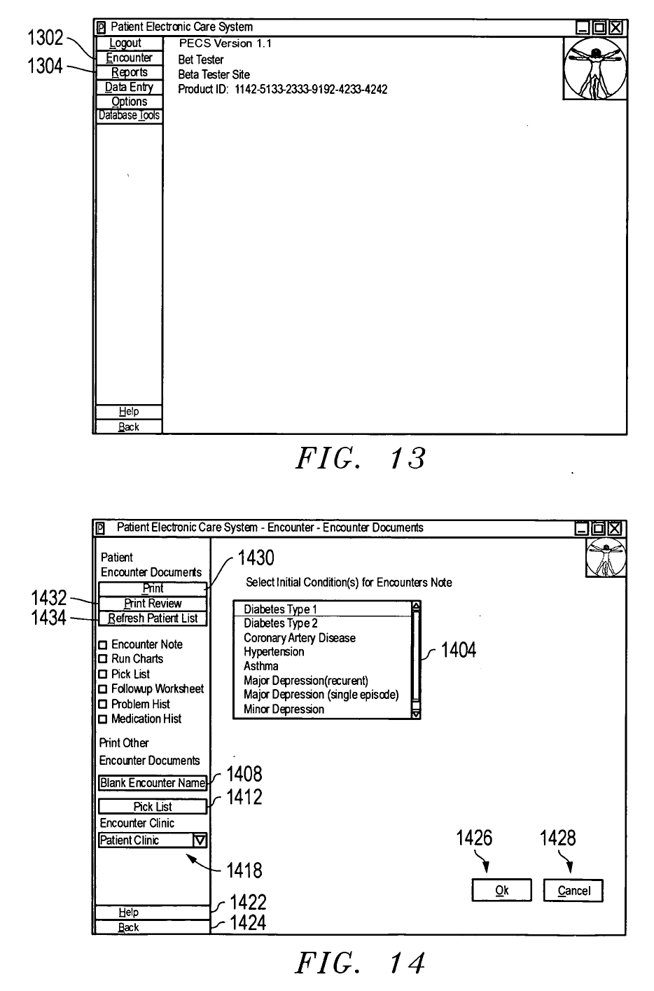

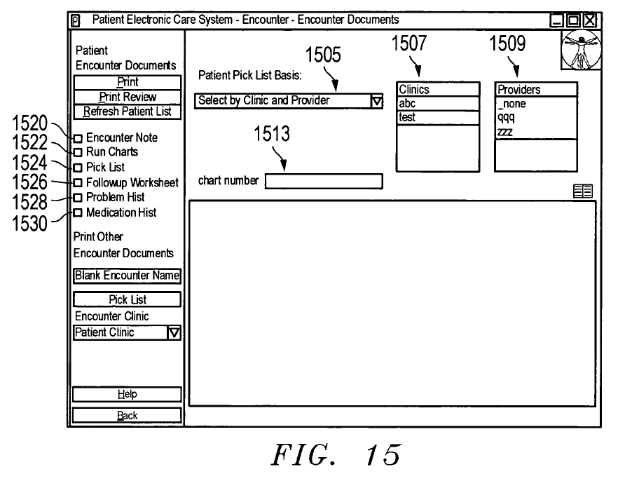

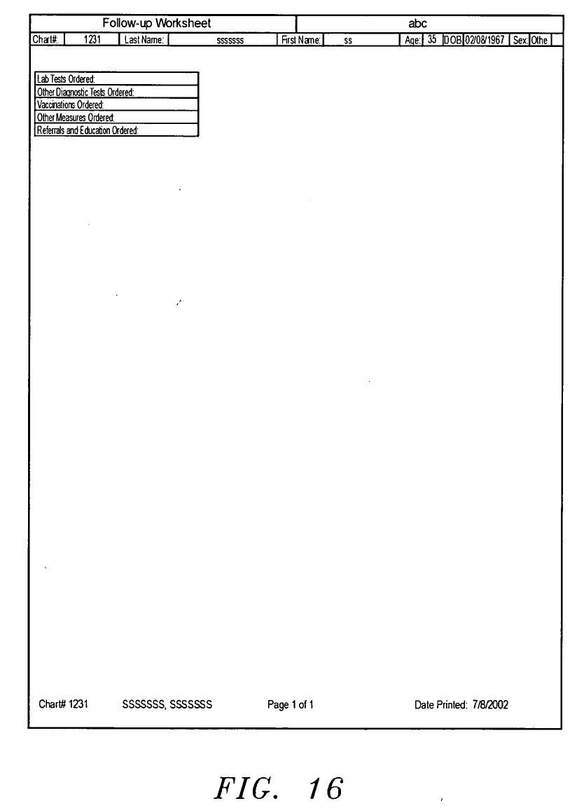

FIG. 15 illustrates another menu that may be used to customize an encounter document for a particular clinic and patient. For example, user selectable elements 1505, 1507 and 1509 are used to select the appropriate clinic and provider so that a desired pick list can be populated with information customized to a particular clinic or provider. In addition, user completion field 1513 can be completed with a chart number so that the pick list appropriate for a particular patient can be generated. Note also that encounter note 1520, run charts 1522, pick list 1524, follow up worksheets 1526, problem history 1528 and medication history 1530 are also selectable to generate or display various types of forms, reports, etc. For example, FIG. 16 illustrates a sample follow up worksheet, FIG. 17 illustrates a problem history form, and FIG. 18 illustrates a medication history form.

Referring next to FIGS. 19-28 various data entry screens are illustrated. FIG. 19 illustrates a data entry screen that allows a user to choose a type of data entry operation to perform. For example the user may select new patient button 1902, add patient data 1904, edit patient data 1906, configure run charts 1908, make patient active 1910, make patient inactive 1912 and set effective dates 1914, as desired to perform certain data entry operations.

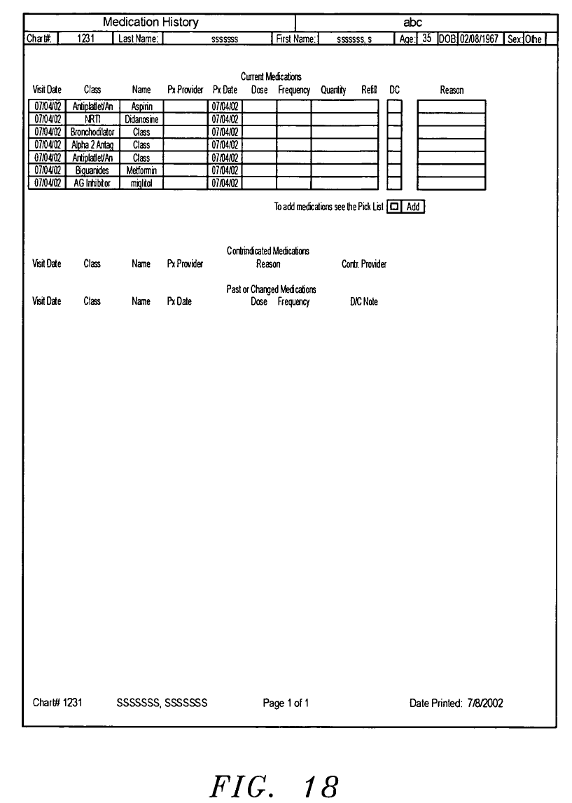

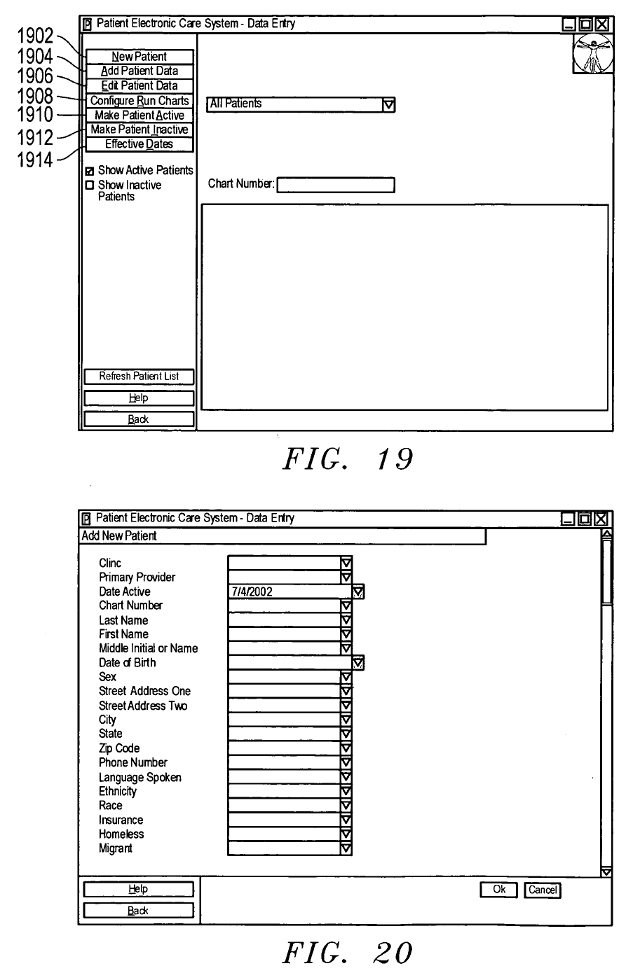

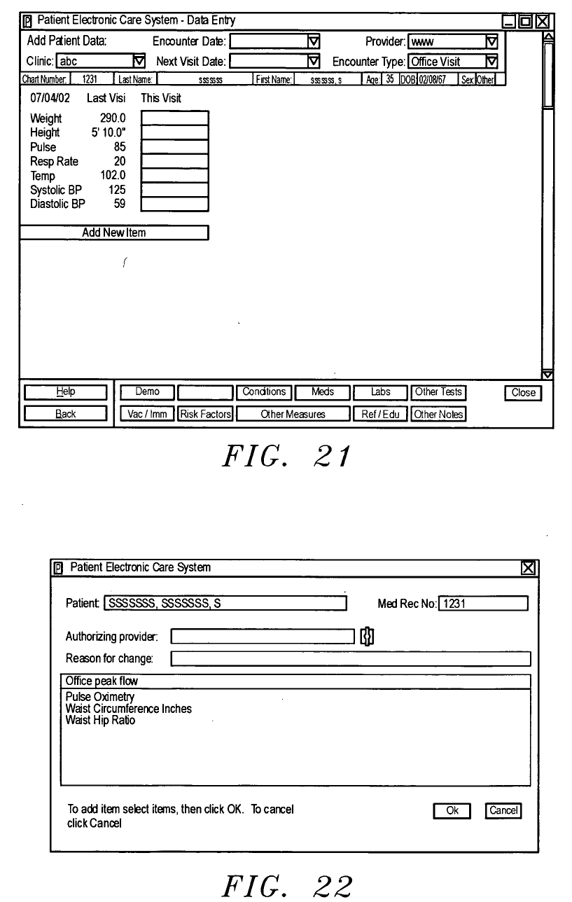

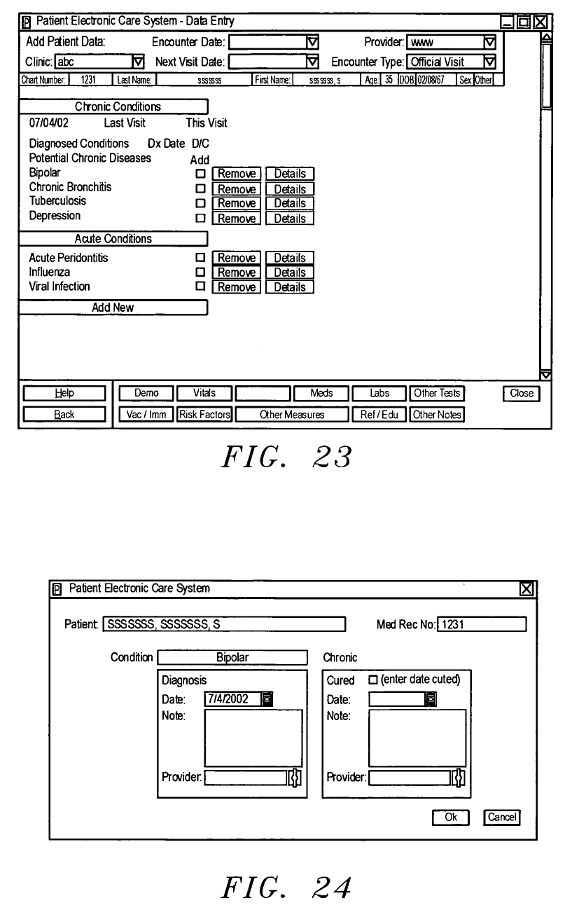

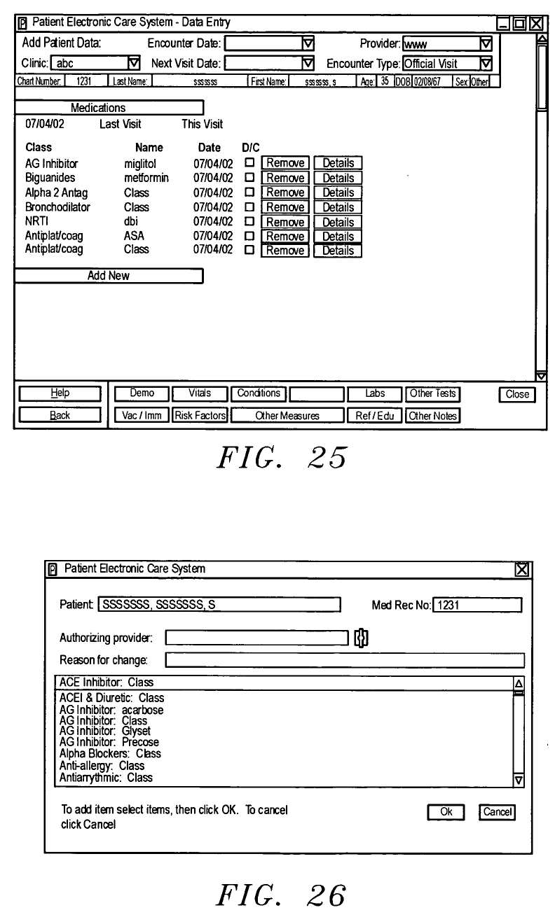

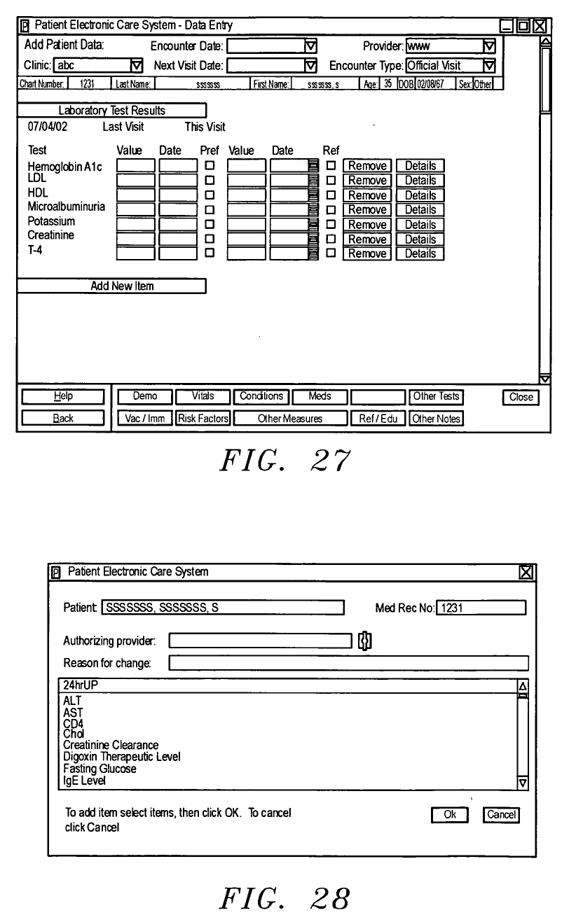

FIG. 20 illustrates a form according to an embodiment of the present disclosure for entering new patient data when the new patient button 1902 (FIG. 19) is selected. FIGS. 21 and 22 illustrate two screens used in various embodiments of the present disclosure to add patient data relating to vital statistics. FIGS. 23 and 24 illustrate two data entry screens that may be used according to an embodiment of the present disclosure to add patient data related to diseases of the patient. FIGS. 25 and 26 illustrate two screens that may be used to add patient data related to medications, while FIGS. 27 and 28 illustrate two screens that may be used to enter patient data related to laboratory tests. Note that in one embodiment, the screens shown in FIGS. 21-28 may be accessed/displayed when a user selects a corresponding user selectable object at the bottom of the screens illustrated in FIGS. 21, 23, 25 and 27. Additional data entry screens that may be used to facilitate data entry include screens for entry of test data, vaccination and immunization data, risk factor data, other measures data, referral and education data and other notes.

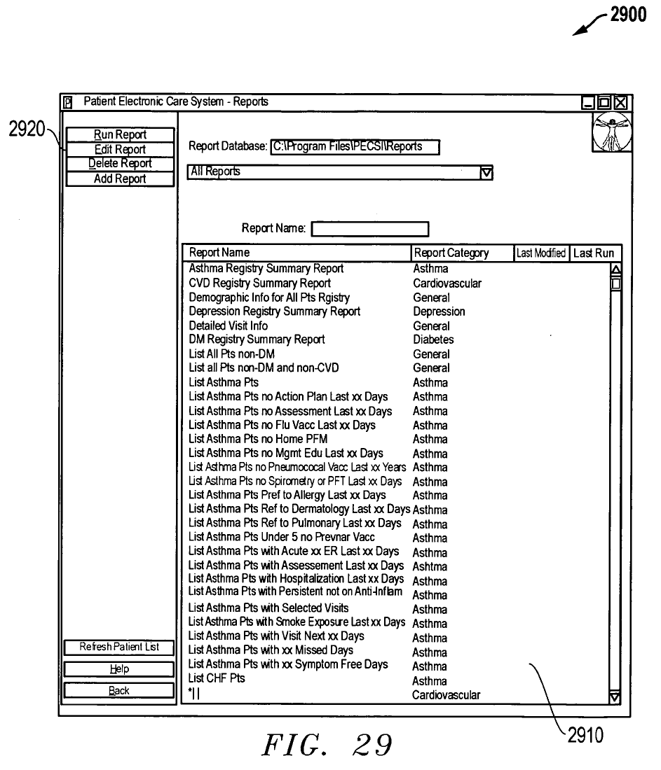

Referring next to FIG. 29 a report selection screen according to an embodiment of the present disclosure is illustrated and designated report selection screen 2900, report selection screen 2900 includes report list 210, which allows an end user to select from a large list of possible reports upon which to base their customized report. For example, if a user desires to select a report dealing generally with asthma, he has a large array of options. Each of the particular reports selected from report list 210 can then be further modified by choosing the edit report object 2920. Continuing with the previous example, assume that a medical provider desires to find out if an asthma treatment that he has been using for most of his patients is effective. In that case, the medical provider may select the list asthma patients with XX symptom free days report from report list 210. The selected report can then be further modified to limit the patients included in the report to patients that have been treated only under a specific treatment regime to only patients who have been hospitalized within the last twelve days, or any other number of criteria. In effect, the medical professional can, by interacting with a graphical user interface according to an embodiment of the present disclosure, generate a custom report without requiring the services of a technical professional to preconstruct the report using complex database queries.

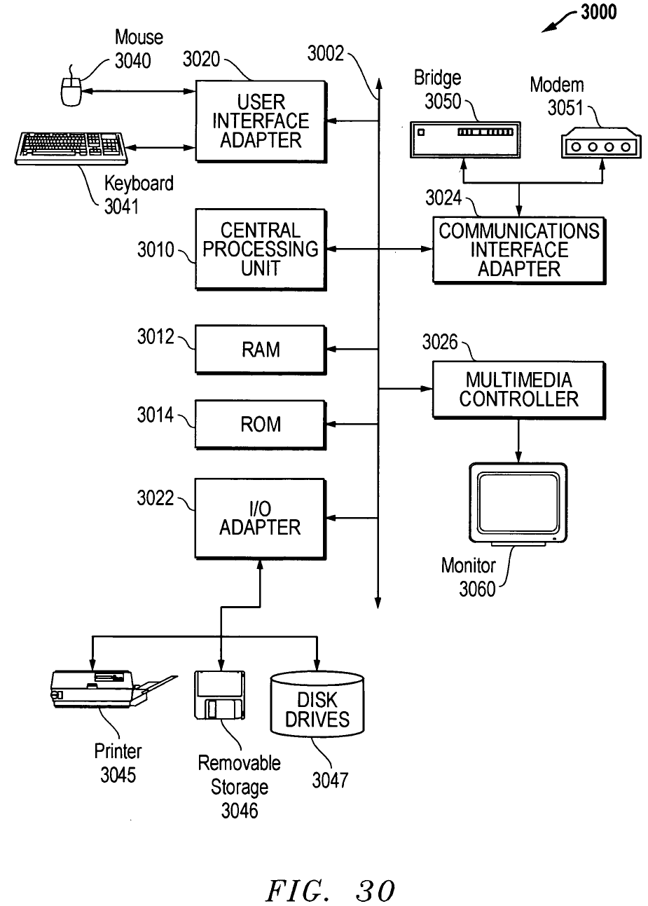

Referring next to FIG. 30 a block diagram of a system according to an embodiment of the present disclosure will be discussed, and is designated generally processor 3000. Processor 3000 is illustrated to include a central processing unit 3010 which may be a conventional proprietary data processor, memory including random access memory 3012, read only memory 3014, and input output adapter 3022, a user interface adapter 3020, a communications interface adapter 3024, and a multimedia controller 3026. The input output (I/O) adapter 3026 is further connected to and controls disk drives 3047, printer 3045, removable storage devices 3046, as well as other standard and proprietary I/O devices. The user interface adapter 3020 can be considered to be a specialized I/O adapter. The adapter 3020 is illustrated to be connected to a mouse 3040, and a keyboard 3041. In addition the user interface adapter 3020 may be connected to other devices capable of providing various types of user control, such as touch screen devices. The communications interface adapter 3024 is connected to a bridge 3050 such as is associated with a local or a wide area network, and a modem 3051. By connecting the system bus 3002 to various communication devices, external accessed information can be obtained. The multimedia controller 3026 will generally include a video graphics controller capable of displaying images upon the monitor 3060, as well as providing audio to external components (not illustrated). Generally, the system 3000 will be capable of implementing the system and methods described herein.

In summary, then, patient information associated with particular patient's medical conditions or issues may be stored in a database. A medical professional or other end user may retrieve the information from the database as a form containing primarily only the relevant information related to a particular patient's medical condition. Similar forms containing substantially only information relevant to a patient's medical condition can also be used to facilitate entry of the patient information into a database. In addition, end users can easily generate reports from the database. Reports, forms and data entry forms can all be constructed in a customized, or dynamic, manner without requiring the assistance of technical professionals to preconstruct form templates.

One of the implementations of the invention is as sets of computer readable instructions resident in the random access memory of one or more processing systems configured generally as described in FIGS. 1-30. Until required by the processing systems the set of instructions may be stored in another computer readable memory, for example, in a hard disk drive or in a removable memory such as optical disc for eventual use in a compact disc (CD) drive or digital video disc (DVD) drive or a floppy disk for eventual use in a floppy disk drive. Further, the set of instructions can be stored in the memory of another processing system and transmitted over a local area network or a wide area network, such as the internet, where the transmitted signal could be a signal propagated through a medium such as an ISDN line, or the signal may be propagated through an air medium and received by a local satellite to be transferred to the processing system. Such a signal may be a composite signal compromising a carrier signal and contained within the carrier signal is the desired information containing at least one computer program instruction implementing the invention, and may be downloaded as such when desired by the user. One skilled in the art would appreciate that the physical storage and/or transfer of the sets of instructions physically changed the medium upon which it is stored electrically, magnetically, or chemically so that the medium carries computer readable information.

An embodiment of the present invention has been shown and described in detail herein, along with certain variants thereof, and many other varied embodiments that incorporate the teachings of the invention may be easily constructed by those skilled in the art. Benefits, other advantages, and solutions to problems have been described above with regard to specific embodiments. However, the benefits, advantages, solutions to problems, and any elements that may cause any benefit, advantage, or solution to occur or become more pronounced are not to be construed as a critical, required, or essential feature or element of any or all the claims. Accordingly the present invention is not intended to be limited to the specific set forth herein, but on the contrary it is intended to cover such alternatives, modifications, and equivalents, as can reasonably be included within the spirit and scope of the claimed invention.

What is claimed is:

1. A method comprising:
obtaining information associated with an individual's medical condition;
selecting information to be presented to a medical provider based on the information retrieved; and
presenting the selected information to the medical provider in an integrated format.

2. The method as in claim 1, further including;
collecting the information associated with an individual's medical condition; and
storing the collected information in a database.

3. The method as in claim 1, wherein information associated with an individual's medical condition includes diseases.

4. The method as in claim 1, wherein information associated with an individual's medical condition includes treatment history.

5. The method as in claim 1, wherein information associated with an individual's medical condition includes risk factors.

6. The method as in claim 1, wherein information associated with an individual's medical condition includes the individual's vital statistics.

7. The method as in claim 1, wherein selecting information includes selecting care guidelines associated with the individual's medical condition.

8. The method as in claim 7, wherein care guidelines include medical tests likely to be required.

9. The method as in claim 7, wherein care guidelines include potential side effects of prescription medication to watch for.

10. The method as in claim 7, wherein care guidelines include information associated with referrals.

11. The method as in claim 1, wherein selecting information includes suppressing information to be excluded from presentation.

12. The method as in claim 1, wherein presenting the selected information includes printing a form.

13. The method as in claim 1, wherein presenting the selected information includes saving the selected information to a computer readable file.

14. The method as in claim 1, wherein presenting the selected information includes presenting the selected information on a display device.

15. The method as in claim 14, wherein presenting the selected information on a display device includes presenting the selected information in an interactive format.

16. A method comprising:
identifying a combination of medical issues particular to an individual; and
presenting, to a medical provider for the individual, information related to the combination of medical issues in an integrated format.

17. The method as in claim 16, further including;
collecting information associated with the individual;
storing the collected information in a database; and wherein
the combination of medical issues is identified using the stored information.

18. The method as in claim 16, wherein the combination of medical issues include a disease.

19. The method as in claim 16, wherein the combination of medical issues include a prior treatment event.

20. The method as in claim 16, wherein the combination of medical issues include a risk factor.

21. The method as in claim 16, wherein the combination of medical issues a vital statistic.

22. The method as in claim 16, wherein information related to the combination of medical issues includes a care guideline.

23. The method as in claim 22, wherein the care guideline includes a medical test likely to be required.

24. The method as in claim 22, wherein the care guideline includes an alert to a potential side effect of prescription medication.

25. The method as in claim 22, wherein the care guideline includes information associated with a referral.

26. The method as in claim 16, wherein presenting information related to the combination of medical issues includes suppressing information to be excluded from presentation.

27. The method as in claim 16, wherein presenting information related to the combination of medical issues includes printing a form.

28. The method as in claim 16, wherein presenting information related to the combination of medical issues includes saving the selected information to a computer readable file.

29. The method as in claim 16, wherein presenting information related to the combination of medical issues presenting the selected information on a display device.

30. The method as in claim 29, wherein presenting the selected information on a display device includes presenting the selected information in an interactive format.

31. A method comprising:
collecting items of information associated with a patient's medical condition;
storing the items individually in a medical database;
selecting elements associated with the patient's medical condition to include on a form, wherein the selection is based on the items stored in the medical database; and
generating the form.

32. The method as in claim 31, wherein collecting items of information includes obtaining information via an interactive display.

33. The method as in claim 31, wherein information associated with a patient's medical condition includes diseases.

34. The method as in claim 31, wherein information associated with a patient's medical condition includes treatment history.

35. The method as in claim 31, wherein information associated with a patient's medical condition includes risk factors.

36. The method as in claim 31, wherein information associated with a patient's medical condition includes the individual's vital statistics.

37. The method as in claim 31, wherein elements to include on a form include care guidelines associated with the patient's medical condition.

38. The method as in claim 37, wherein care guidelines include medical tests likely to be required.

39. The method as in claim 37, wherein care guidelines include potential side effects of prescription medication to watch for.

40. The method as in claim 37, wherein care guidelines include information associated with referrals.

41. The method as in claim 31, wherein selecting elements includes suppressing elements to be excluded from presentation.

42. The method as in claim 31, wherein generating a form includes printing the form.

43. The method as in claim 31, further including saving the form to a computer readable file.

44. The method as in claim 31, wherein generating the form includes presenting the form on a display device.

45. The method as in claim 34, wherein presenting the form on a display device includes presenting the form in an interactive format.

46. A graphical user interface (GUI) comprising:
a patient identification field; and
a plurality of user selectable objects to associate one or more medical issues with a patient.

47. The GUI as in claim 46, further including a plurality of fill-in form fields.

48. The GUI as in claim 46, wherein medical issues include diseases.

49. The GUI as in claim 46, wherein medical issues include treatment history events.

50. The GUI as in claim 46, wherein medical issues include risk factors.

51. The GUI as in claim 46, wherein medical issues include the patient's vital statistics.

53. The GUI as in claim 46, wherein medical issues include medical tests.

54. The GUI as in claim 46, wherein medical issues include medication.

55. The GUI as in claim 46, wherein medical issues include information associated with referrals.

56. A computer readable medium tangibly embodying a program of instructions, said program of instructions comprising instructions to:
retrieve information associated with an individual's medical condition;
select information to be presented to a medical provider based on the information retrieved; and
present the selected information to the medical provider in an integrated format.

57. The computer readable medium as in claim 56, further including instructions to:
collect the information associated with an individual's medical condition; and
store the collected information in a database.

58. The computer readable medium as in claim 56, wherein information associated with an individual's medical condition includes diseases.

59. The computer readable medium as in claim 56, wherein information associated with an individual's medical condition includes treatment history.

60. The computer readable medium as in claim 56, wherein information associated with an individual's medical condition includes risk factors.

61. The computer readable medium as in claim 56, wherein information associated with an individual's medical condition includes the individual's vital statistics.

62. The computer readable medium as in claim 56, wherein said instructions to select information include instructions to select care guidelines associated with the individual's medical condition.

63. The computer readable medium as in claim 62, wherein care guidelines include medical tests likely to be required.

64. The computer readable medium as in claim 62, wherein care guidelines include potential side effects of prescription medication to watch for.

65. The computer readable medium as in claim 62, wherein care guidelines include information associated with referrals.

66. The computer readable medium as in claim 56, wherein said instructions to select information include instructions to suppress information to be excluded from presentation.

67. The computer readable medium as in claim 56, wherein said instructions to present the selected information include instructions to print a form.

68. The computer readable medium as in claim 56, wherein said instructions to present the selected information include instructions to save the selected information to a computer readable file.

69. The computer readable medium as in claim 56, wherein said instructions to present the selected information include instructions to present the selected information on a display device.

70. The computer readable medium as in claim 69, wherein said instructions to present the selected information on a display device include instructions to present the selected information in an interactive format.

71. A system comprising:
a processor;
memory operably coupled to said processor;
a program of instructions to be stored in said memory and executed by said processor, said program of instructions including instructions to:
retrieve information associated with an individual's medical condition;
select information to be presented to a medical provider based on the information retrieved; and
present the selected information to the medical provider in an integrated format.

72. The system as in claim 71, wherein said program of instructions further includes instructions to:
collect the information associated with an individual's medical condition; and
store the collected information in a database.

73. The system as in claim 71, wherein information associated with an individual's medical condition includes diseases.

74. The system as in claim 71, wherein information associated with an individual's medical condition includes treatment history.

75. The system as in claim 71, wherein information associated with an individual's medical condition includes risk factors.

76. The system as in claim 71, wherein information associated with an individual's medical condition includes the individual's vital statistics.

77. The system as in claim 71, wherein said instructions to select information include instructions to select care guidelines associated with the individual's medical condition.

78. The system as in claim 77, wherein care guidelines include medical tests likely to be required.

79. The system as in claim 77, wherein care guidelines include potential side effects of prescription medication to watch for.

80. The system as in claim 77, wherein care guidelines include information associated with referrals.

81. The system as in claim 71, wherein said instructions to select information include instructions to suppress information to be excluded from presentation.

82. The system as in claim 71, wherein said instructions to present the selected information include instructions to print a form.

83. The system as in claim 71, wherein said instructions to present the selected information include instructions to save the selected information to a computer readable file.

84. The system as in claim 71, wherein said instructions to present the selected information include instructions to present the selected information on a display device.

85. The system as in claim 84, wherein said instructions to present the selected information on a display device include instructions to present the selected information in an interactive format.

86. A method of obtaining information from a medical database, the method comprising:
presenting a medical database interface to an end-user;
obtaining one or more filtering criteria from the end-user via the medical database interface;
filtering data in the medical database based on the one or more filtering criteria obtained; and
generating a report including the filtered data.

87. The method as in claim 86, further including generating a report file including the one or more filtering criteria, wherein the report file is usable to supply filtering criteria during subsequent filtering operations.
